(19) United States
(12) Patent Application Publication
(10) Pub. No.: US 2026/0313673 A1
(43) Pub. Date: Oct. 8, 2026

(54) ARTIFICIAL INTELLIGENCE (AI)-DRIVEN OPEN CLOUD RADIO ACCESS NETWORK (RAN) PROGRAMMABILITY FOR MULTI-GENERATION DEVICES

(71) Applicant: AT&T Intellectual Property I, L.P., Atlanta, GA (US)

(72) Inventors: Hongyan Lei, Plano, TX (US); Ye Chen, Marietta, GA (US); Zhi Cui, Sugar Hill, GA (US)

(73) Assignee: AT&T Intellectual Property I, L.P., Atlanta, GA (US)

(21) Appl. No.: 19/098,016

(22) Filed: Apr. 2, 2025

(51) Int. Cl. H04W 72/52

(52) U.S. Cl. CPC H04W 72/52

(57) ABSTRACT

Aspects of the subject disclosure may include, for example, allocating radio access network (RAN) resources to support first devices that utilize a first radio access technology (RAT) and second devices that utilize a second RAT, resulting in a resource allocation, obtaining information regarding a quantity of the first devices, a quantity of the second devices, traffic loads associated with the first devices, traffic loads associated with the second devices, or a combination thereof, and adjusting the resource allocation based on the information. Other embodiments are disclosed.

### FIELD OF THE DISCLOSURE

The subject disclosure relates to artificial intelligence (AI)-/machine learning (ML)-driven open cloud radio access network (RAN) programmability for multi-generation devices.

### BACKGROUND

The evolution of mobility technology is a continuous process, with new generations of technology emerging approximately every decade. Currently, the deployment of 5G technology is underway, while the development of 6G technology is gradually taking shape, with expectations for its introduction in around 2030. A significant challenge in the introduction of new technology generations is the need for backwards compatibility and the management of legacy devices.

While network configurations can be updated swiftly, the phasing out of legacy devices is a prolonged process. Smartphones typically have a lifespan of about 3 to 5 years, whereas Internet-of-Things (IoT) devices can last for over 10 years. To accommodate these legacy devices, operators are compelled to reserve certain spectrum allocations for older technologies. Additionally, maintaining legacy network equipment and operations is also necessary, despite the availability of newer, more efficient, and cost-effective technologies. This requirement imposes a substantial burden on operators, who must manage multi-generation Radio Access Network (RAN) systems.

### BRIEF DESCRIPTION OF THE DRAWINGS

Reference will now be made to the accompanying drawings, which are not necessarily drawn to scale, and wherein:

FIG. 1A is a block diagram illustrating an exemplary, non-limiting embodiment of a communications network in accordance with various aspects described herein.

FIG. 1B is a block diagram illustrating an example, non-limiting embodiment of a system functioning within, or operatively overlaid upon, the communications network of FIG. 1A in accordance with various aspects described herein.

FIG. 2A is a block diagram illustrating an example, non-limiting embodiment of a system functioning within, or operatively overlaid upon, the communications network of FIG. 1A and/or the system of FIG. 1B in accordance with various aspects described herein.

FIG. 2B depicts an illustrative embodiment of a method in accordance with various aspects described herein.

FIG. 2C is a diagram of an example AI architecture, which may be used to facilitate training or pre-training of one or more AI models, including, for instance, large language models (LLMs), in accordance with various aspects described herein.

FIG. 2D is a diagram of an example transformer model, a portion or an entirety of which may serve as a functional building block of one or more LLMs, in accordance with various aspects described herein.

FIG. 3 is a block diagram illustrating an example, non-limiting embodiment of a virtualized communications network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes illustrative embodiments of an AI/ML-driven resource allocation platform that enables a RAN to support devices across different generations of radio access technologies (RATs). Exemplary embodiments may leverage the programmability and flexibility of open cloud RAN architectures to provide resource support for the various devices. In one or more embodiments, the platform may (e.g., periodically, on-demand, or based on one or more criteria being satisfied) dynamically program the RAN to utilize a portion of the air interface to communicate with legacy devices. The RAN may thus be configured to (e.g., simultaneously) support multiple technologies over the air interface, enabling the operator of the RAN to serve modern or non-legacy devices as well as legacy ones. In one or more embodiments, the platform may employ AI/ML to drive RAN software to adaptively transmit and receive signaling/messages for a variety of RATs, such as, for instance, Long Term Evolution (LTE), 5G, 6G, etc. based on the types of device that are present in a given coverage area, based on traffic load(s) associated with each type of RAT, or a combination thereof. In certain embodiments, the platform may facilitate the translation of signaling/messages from one RAT to another, and may communicate the translations with the core network as needed. For example, the platform may translate LTE signaling and data received over the air interface into 5G signaling and data to work with a 5G core.

Dynamically allocating spectrum resources for legacy devices on-demand allows the RAN to reduce resource overhead and thus improve spectral efficiency. It also encourages AI/ML innovation across the air interface between the RAN and user devices. AI/ML-based translation of signaling messages between legacy devices and advanced core networks also reduces or eliminates the need to operate legacy RAN equipment, which simplifies network operations and reduces operating costs.

While various aspects are described herein with respect to LTE/5G/6G/WiFi, it is to be understood and appreciated that the techniques can be similarly applied to or adapted for higher generation RATs and/or other wireless technologies. Additionally, the (e.g., open and cloud-based) platform can be extended to wireline technologies that encounter legacy devices or protocols.

One or more aspects of the subject disclosure include a device, comprising a processing system including a processor, and a memory that stores executable instructions that, when executed by the processing system, facilitate performance of operations. The operations can include allocating radio access network (RAN) resources to support first devices that utilize a first radio access technology (RAT) and second devices that utilize a second RAT, resulting in a resource allocation. Further, the operations can include obtaining information regarding a quantity of the first devices, a quantity of the second devices, traffic loads associated with the first devices, traffic loads associated with the second devices, or a combination thereof. Further, the operations can include adjusting the resource allocation based on the information.

One or more aspects of the subject disclosure include a non-transitory machine-readable medium, comprising executable instructions that, when executed by a processing system including a processor, facilitate performance of operations. The operations can include allocating radio access network (RAN) resources to support first devices that utilize a first radio access technology (RAT) and second devices that utilize a second RAT, resulting in a resource allocation, wherein the allocating comprises allocating only a portion of a first spectrum resource or a first bandwidth that is associated with the first RAT. Further, the operations can include obtaining data regarding a quantity of the first devices, a quantity of the second devices, traffic loads associated with the first devices, traffic loads associated with the second devices, or a combination thereof. Further, the operations can include adjusting the resource allocation based on the data.

One or more aspects of the subject disclosure include a method. The method can comprise allocating, by a processing system including a processor, radio access network (RAN) resources to support first devices that utilize a first radio access technology (RAT) and second devices that utilize a second RAT, resulting in a resource allocation, wherein the processing system comprises or is included in a control or centralized unit (CU) or a distributed unit (DU) of an open cloud RAN. Further, the method can include obtaining, by the processing system, information regarding a quantity of the first devices, a quantity of the second devices, traffic loads associated with the first devices, traffic loads associated with the second devices, or a combination thereof. Further, the method can include adjusting, by the processing system, the resource allocation based on the information.

Other embodiments are described in the subject disclosure.

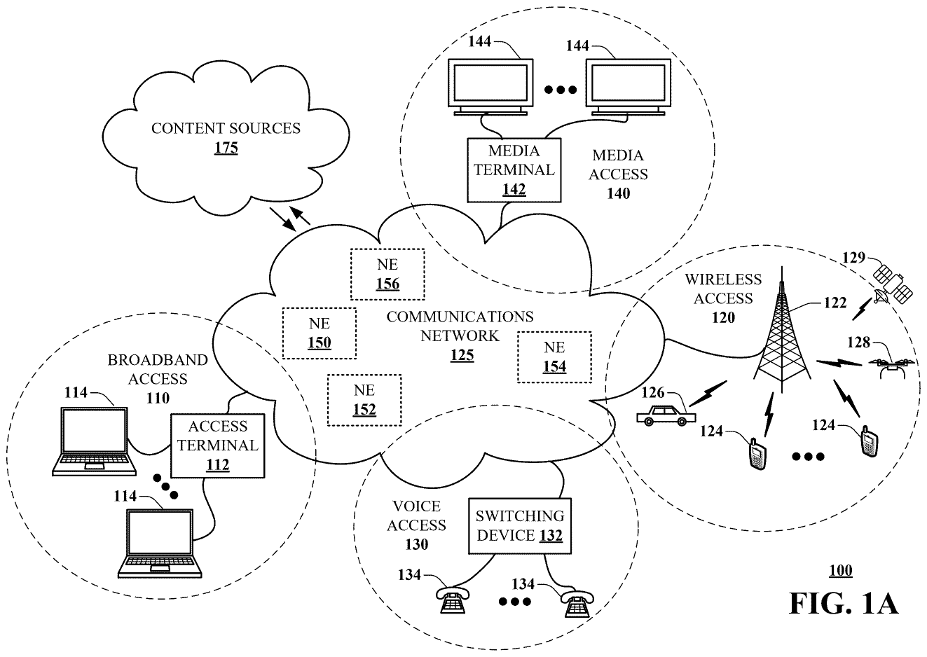

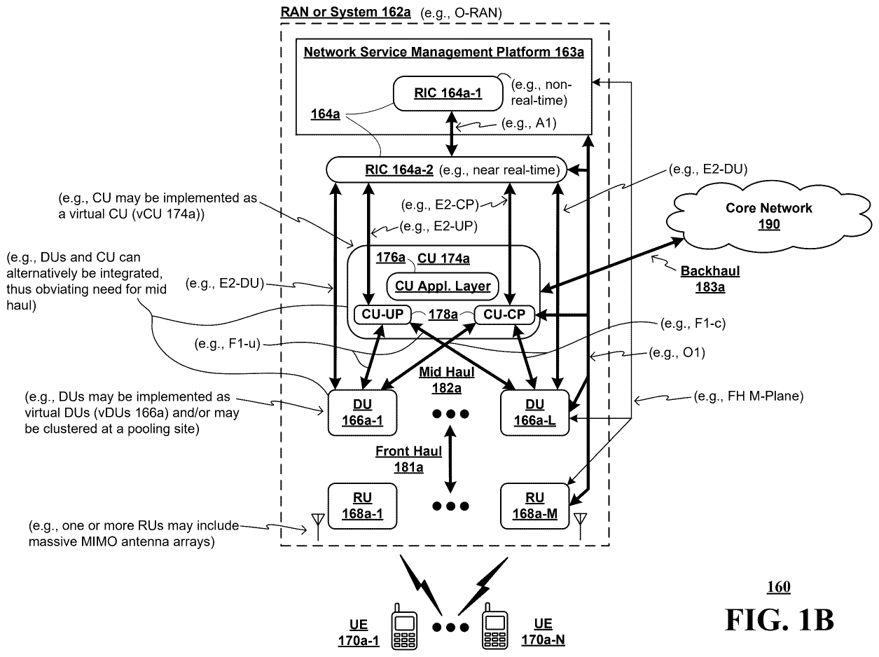

Referring now to FIG. 1A, a block diagram is shown illustrating an example, non-limiting embodiment of a system 100 in accordance with various aspects described herein. For example, system 100 can facilitate, in whole or in part, AI-/ML-driven open cloud RAN programmability to support legacy and non-legacy devices. In particular, a communications network 125 is presented for providing broadband access 110 to a plurality of data terminals 114 via access terminal 112, wireless access 120 to a plurality of mobile devices 124, vehicle 126, and uncrewed aerial vehicle (UAV) 128 via base station or access point 122 (and/or via satellite(s) 129), voice access 130 to a plurality of telephony devices 134, via switching device 132 and/or media access 140 to a plurality of audio/video display devices 144 via media terminal 142. In addition, communications network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or another communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices. In various embodiments, the satellite(s) 129 can be configured for bi-directional communication with one or more access points, with one or more base stations, and/or with one or more mobile devices (e.g., direct-to-cell). In various embodiments, the satellite(s) 129 can include one or more Low Earth Orbit (LEO) satellites or one or more Geostationary Orbit (GEO) satellites.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

FIG. 1B is a block diagram illustrating an example, non-limiting embodiment of a system 160 functioning within, or operatively overlaid upon, the communications network 100 of FIG. 1A in accordance with various aspects described herein. For example, system 160 can, in whole or in part, facilitate AI-/ML-driven open cloud RAN programmability to support legacy and non-legacy devices. In some embodiments, the system 160 may correspond to or include one or more networks (e.g., a communications network, a data network, etc.).

As shown in FIG. 1B, the system 160 may include a RAN 162a communicatively coupled to a core network 190. The core network 190 can include a 5G network, an evolved packet core (EPC) network, a higher generation network, or any combination thereof. In various embodiments, the RAN 162a may be or may include a virtual RAN (vRAN) (e.g., in an O-RAN implementation or an open cloud RAN implementation) in which software is decoupled from hardware and implementation thereof is in accordance with principles of network function virtualization (NFV), where the control plane is separated from the data plane. The vRAN may include a centralized set of baseband units located remotely from antennas and remote radio units and may be configured to share signaling amongst cells.

As shown in FIG. 1B, the RAN 162a may include a network service management platform 163a and a RAN intelligent controller (RIC) 164a. The RIC 164a may include a RIC portion 164a-1 implemented, or otherwise incorporated, in the network service management platform 163a. The RIC 164a may include a RIC portion 164a-2 having a control or centralized unit (CU) 174a (e.g., a base station CU, such as a gNodeB (gNB) CU or the like) that provides a CU applications layer 176a as well as a CU control plane CU-CP and a CU user plane CU-UP (e.g., represented as CU-CP & CU-UP 178a). In various embodiments, the RIC portion 164a-1 may be configured to operate in non-real-time, and the RIC portion 164a-2 may be configured to operate in near real-time. The particular functions performed by the RIC portions 164a-1, 2 can vary based on various criteria, including implementing changing parameters or requirements for the network, and can also include redundancy and/or dynamic switching of functions (including functions described herein) between the RIC portions 164a-1, 2.

As shown in FIG. 1B, the RAN 162a may include distributed units (DUs) 166a-1 through 166a-L (L≥1) (hereinafter referred to collectively as “DUs 166a,” and individually as “DU 166a”). In various embodiments, the DUs 166a may include baseband units (e.g., base station DUs, such as gNB DUs or the like) configured to perform signal processing, UE scheduling, and/or the like. In exemplary embodiments, each of one or more DUs 166a may be implemented as a virtual DU (vDU). The RAN 162a may also include remote radio heads or remote units (RUs) 168a-1 through 168a-M (M≥1) (hereinafter referred to collectively as “RUs 168a,” and individually as “RU 168a”). The RUs 168a may communicatively couple (e.g., via an air interface) with user equipment (UEs) 170a-1 through 170a-N (N≥1) (hereinafter referred to collectively as “UEs 170a,” and individually as “UE 170a”). In various embodiments, the RUs 168a may include remote radio units, antennas, and/or the like. In one or more embodiments, each of one or more RUs 168a may include one or more antenna arrays (e.g., massive MIMO arrays).

A UE 170a may be any computing device that is capable of obtaining and/or processing data and communicating information with one or more other devices (e.g., over the network 200). As some non-limiting examples, a UE may be a communication device (e.g., a router, a modem, a mobile phone, or a wearable device, such as a smart wristwatch, a pair of smart eyeglasses, media-related gear (e.g., augmented reality (AR), virtual reality (VR), or mixed reality (MR) glasses and/or headset/headphones)), a biometric sensor (e.g., for monitoring heart rate, blood pressure, pulse, breathing, etc.), an electrical switch controller, a security camera, an automated assistant, a smart TV, an environmental sensor/controller (e.g., for lighting, temperature, audio, etc.), a kitchen/bath appliance controller (e.g., for a stove, a dehumidifier, etc.), a drapery (e.g., curtain, shade, blinds, or the like) controller, a door/lock controller (e.g., for a room door, a garage door, etc.), a tracking device (e.g., for tracking objects on the road, in a factory/warehouse setting, etc.), a vehicle, a similar type of device, a different type of device, or a combination of some or all of these devices. In various embodiments, the UEs 170a may employ particular RATs. For instance, some UEs 170a may be configured to employ LTE technology, other UEs 170a may be configured to employ 5G technology, yet other UEs 170a may be configured to employ 6G technology, and so on. UEs 170a that employ higher generation technologies (e.g., 5G, 6G, or beyond) may be referred to herein as non-legacy devices or devices that utilize non-legacy RAT(s), whereas UEs 170a that employ older generation technologies (e.g., LTE and/or 5G in the context of a 6G RAN/core) may be referred to herein as legacy devices or devices that utilize legacy RAT(s).

As shown in FIG. 1B, the RUs 168a, the DUs 166a, and the CU 174a may, by way of a fronthaul 181a, a midhaul 182a, and a backhaul 183a, provide (e.g., controlled) connectivity between the core network 190 and the UEs 170a. In one or more embodiments, the fronthaul 181a, the midhaul 182a, and/or the backhaul 183a may conform to open standards, such as O-RAN standards or the like. In certain embodiments, a given DU 166a may reside at a central location (away from cell towers) and may be communicatively coupled to multiple RUs (e.g., distributed across a geographic area) via a fronthaul 181a (split fronthaul).

Although FIG. 1B illustrates the CU 174a and the RIC portion 164a-2 as being distinct from one another, in various embodiments, the CU 174a may alternatively be incorporated in the RIC portion 164a-2. In some embodiments, the RIC 164a and the network service management platform 163a may operate as part of one or more central control planes that oversee a geographic region that can include multiple (e.g., hundreds, thousands, etc.) of remote units, distributed units, centralized units, or any combination thereof.

In various embodiments, the system 160 may be functionally separated or segmented in accordance with one or more time-based zones or frames. For example, the network service management platform 163a and/or the RIC portion 164a-1 may be operative at or in non-real-time; the RIC portion 164a-2 and/or the CU 174a may be operative at or in near-real-time; and the DUs 166a, the RUs 168a, and/or the UEs 170a may be operative at or in real-time. As the terms (and related terms) are used herein, real-time operations may occur over a span of fractions of a second up to a second (or the like), near-real-time operations may occur over the course of a few seconds (e.g., 1 to 5 seconds or the like), and non-real-time operations may occur over a time period that is greater than a few seconds (e.g., greater than 5 seconds or the like).

In various embodiments, the network service management platform 163a may manage, or otherwise adapt, RIC behaviors and/or operations across one or more of the three time zones or timeframes described above (e.g., real-time, near-real-time, and non-real-time) on an individualized and/or collective basis. Such management or adaptation of RIC behaviors and/or operations may conform to one or more models or microservices (e.g., AI models or microservices) or network applications (e.g., rAPPs, xAPPs), as described herein. In turn, the RIC may establish and/or modify policies and/or behaviors of respective CUs, DUs, and RUs in accordance with the model(s) or microservice(s). In this regard, the network service management platform 163a may indirectly influence the behaviors and/or operations of CUs, DUs, and/or RUs via one or more RICs.

In some embodiments, the communication channels and/or links between the RAN 162a and the UEs 170a may include wireless links. In various embodiments, some or all of the UEs 170a may be mobile and may therefore enter and/or exit a service or coverage area associated with the RIC 164a. In various embodiments, some of the UEs 170a may include non-mobile or stationary devices. In some of these embodiments, the RAN 162a may include one or more routers, gateways, modems, cables, wires, and/or the like, and the communication channels and/or links between the RAN 162a and such UEs may include wired/wireline links, optical links, etc.

In various embodiments, a RIC (e.g., the RIC portions 164a-1, 2 of the RIC 164a) may store, execute, and/or deploy applications or microservices that are configured to control and manage a RAN (e.g., the RAN 162a). In one or more embodiments, for example, the RIC portion 164a-1 may store, execute, and/or deploy rApps, and the RIC portion 164a-2 may store, execute, and/or deploy xApps (e.g., in or via an applications layer, such as the CU applications layer 176a). The applications or microservices may relate to beam designing/forming responsibility allocation, scheduler capacity optimization, coverage optimization, capacity optimization (including, for example, via interference mitigation), user quality optimization (including, for example, for the uplink (UL) and/or the downlink (DL)), radio connection management, mobility management, quality-of-service (QoS) management, interference management, telemetry, network traffic control and/or management, device admissions (e.g., UE admissions control), and/or the like. In various embodiments, an application may include one or more models, such as AI (e.g., ML) models that, when executed in one or more containers, provide corresponding microservices. Deployment of an AI model in a RIC (or, more generally, a RAN) may involve, or include, for example, executing or instantiating the AI model in one or more containers in the RIC portion 164a-1 and/or the applications layer of the RIC portion 164a-2 (e.g., the CU applications layer 176a), such that the AI model processes inputs (e.g., received from other microservices running on the RIC and/or from various components of the RAN, such as the CU-CP & CU-UP 178a, the DUs 166a, and/or the RUs 168a) and provides outputs (e.g., to the other microservices and/or the various components of the RAN), in accordance with the AI model, to control the overall operation of the RAN.

It is to be appreciated and understood that the system 160 can include various quantities of cells (e.g., primary cells (Pcells) and/or secondary cells (Scells)), various quantities of network nodes in a cell, and/or various types of network nodes and/or cells (e.g., heterogeneous cells, etc.).

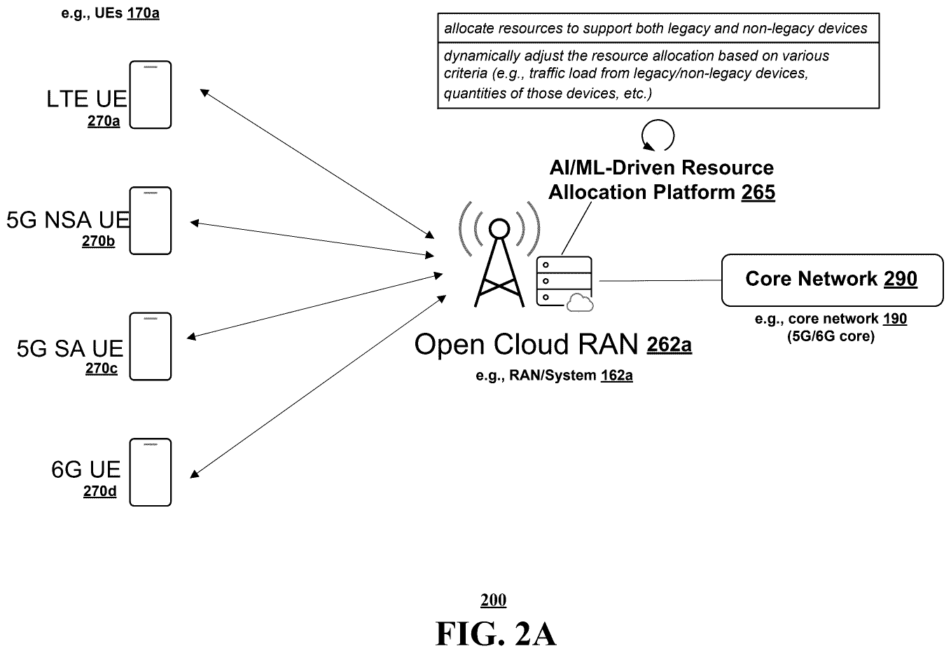

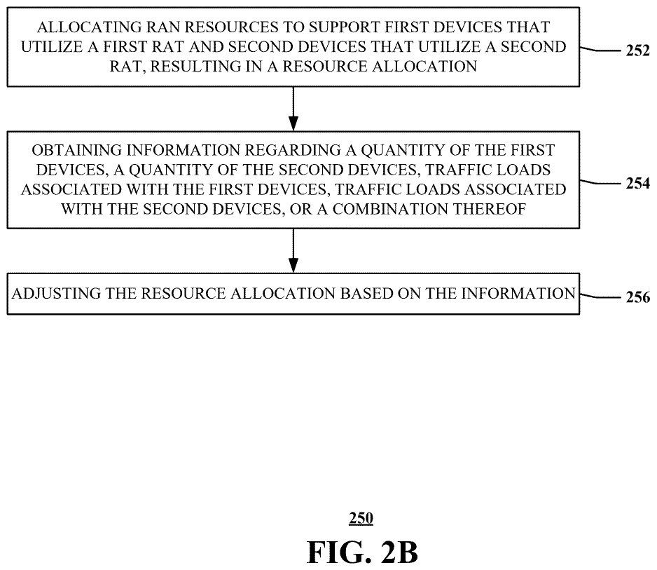

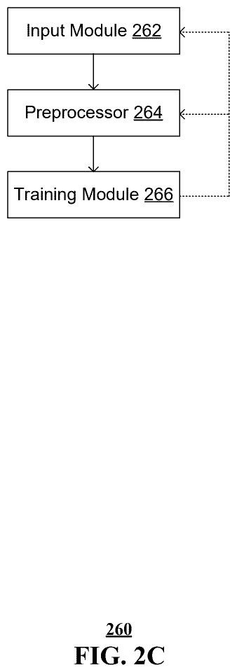

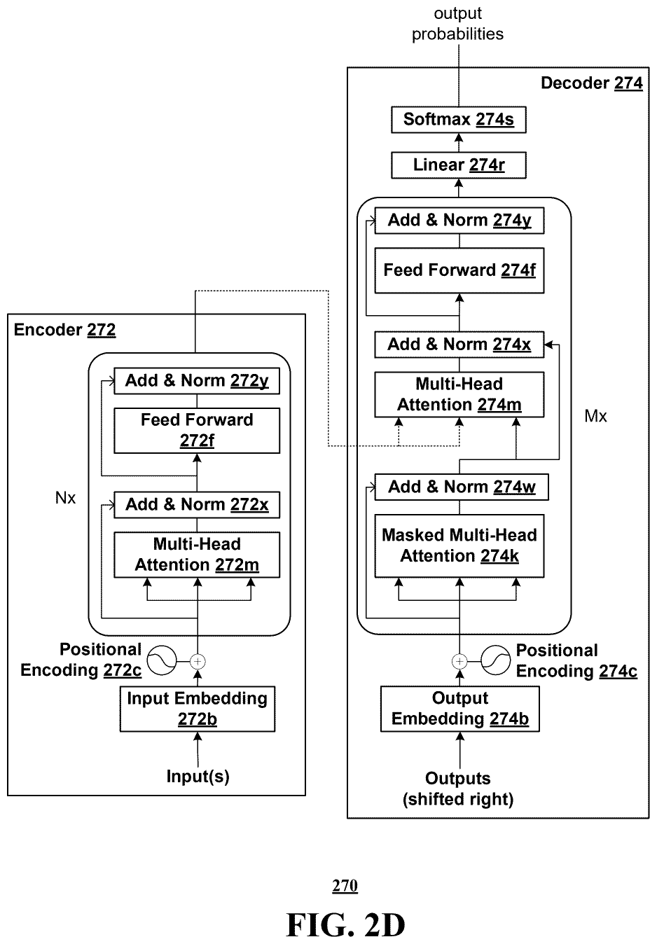

FIG. 2A illustrates an example system/network 200 in which open cloud RAN programmability is leveraged to provide dynamic, AI/ML-driven resource allocation for multi-generation devices, in accordance with various aspects described herein. The system 200 may include an open cloud RAN 262a and a core network 290. Various UEs 270a to 270d may establish communications with the open cloud RAN 262a. In various embodiments, the open cloud RAN 262a may correspond to, may include, or may be incorporated in the RAN/system 162a of FIG. 1B. In one or more embodiments, the core network 290 may correspond to, may include, or may be incorporated in the core network 190 of FIG. 1B. In certain embodiments, the UEs 270a to 270d may correspond to or may include various of the UEs 170a of FIG. 1B.

The open cloud RAN 262a may be programmable, via an AI/ML-driven resource allocation platform 265, to adaptively transmit/receive signaling for various RATs. The programming may be effected based on one or more criteria, such as the types of devices or their associated RATs that are present in a given coverage provided by one or more RUs, the levels of traffic corresponding to the various RATs, or a combination thereof. In various embodiments, the open cloud RAN 262a may be implemented in accordance with software-defined network (SDN) and/or virtualization principles. For instance, in a case where the open cloud RAN 262a is implemented in a vRAN, the resources associated with virtual DU (vDU) and/or virtual CU (vCU) functions for various RATs (e.g., LTE, 5G, 6G, etc.) can be dynamically allocated based on the one or more criteria. In certain embodiments, the platform 265 may be implemented in a CU or in a DU or, alternatively, may be distributed across a CU and one or more DUs. In some embodiments, individual instances of the platform 265 may be implemented in multiple CUs and/or multiple DUs. In any case, implementing the platform 265 in CU(s)/DU(s) (i.e., rather than in a RIC) allows for reduced latency and thus faster resource allocation decision-making due to its closeness or proximity to the edge of the network.

In one or more embodiments, the platform 265 may be configured to effect granular divisions of the air interface resources, and dynamically allocate a portion of the resources to support devices that use certain (e.g., legacy) RATs, while maintaining a majority of the resources to support devices that use other (non-legacy) RATs. In this way, the platform 265 may facilitate the open cloud RAN 262a's transmitting of and/or receiving of signaling for different RATs, all at the same time. This advantageously allows legacy devices to “camp” on the network—i.e., by connecting or locking onto a channel with a base station (e.g., an RU), but not necessarily transmitting data other than perhaps periodic pulses or the like to maintain the coverage—and establishing actual signaling bearers if an actual data transmission connection is needed.

The following describes example functionality of the platform 265 in the context of a 6G RAN and core in which 6G devices and legacy 5G/LTE device are located within a coverage area of the RAN. Here, assume that an operator of the network seeks to utilize most of the spectrum resources for 6G RAT signaling so as to reduce spectrum fragmentation and operational complexity. Different RATs utilize different frequency bands that may be fixed/regulated. For instance, LTE may utilize a first band of frequencies, 5G may utilize a second band of frequencies that is different from the first band, and so on. For a given RU, the allocation of the portion of the air interface spectrum for a particular technology controls how much of the available spectrum within the corresponding fixed frequency band is utilized by the RU. As an example, the platform 265 may be configured to dynamically allocate an RU's available spectrum resources within the various RAT bands based on demand or other factors. That is, the platform 265 may adjust an amount of the RU's total capacity that is dedicated to each RAT at any given time. For instance, within the fixed frequency range of LTE, the platform 265 can adjust an amount of the available bandwidth that is actively used for LTE communications. Where there is a higher demand for LTE (e.g., an increasing number of LTE devices being present in a coverage area, an increasing amount of LTE-based traffic for the LTE devices, etc.), the platform 265 may allocate more of its bandwidth to LTE, effectively using more of the available channels or subcarriers within the LTE band.

In some embodiments, the platform 265 may dynamically allocate a small portion of the available spectrum for broadcasting LTE and/or 5G signaling (e.g., System Information Blocks (SIBs)) such that legacy devices are able to camp onto the network and set up connections as needed. This small portion may be a default portion that is predefined by the network operator. For example, the platform 265 may utilize 10% of the total LTE bandwidth and/or 10% of the total 5G bandwidth to support the respective legacy devices. From the perspective of the individual legacy LTE and/or 5G devices, these devices may detect or “see” the corresponding type of network—i.e., LTE network or 5G network—even if the RAN (aside from perhaps the RUs) and core are predominantly a higher generation RAN and core. As the open cloud RAN 262a may include at least some RUs that are configured to utilize legacy (e.g., LTE, 5G) spectra, allocating a portion of the spectrum for over-the-air interfacing with legacy devices allows the higher generation open cloud RAN 262a to carry traffic even for legacy devices.

In one or more embodiments, the platform 265 may obtain information regarding a quantity of UEs that are using a legacy RAT (e.g., LTE or 5G). The platform 265 may obtain this information from network monitoring systems or signaling data. For instance, network monitoring systems (e.g., including or involving RUs, DUs) may receive communications in a particular coverage area from UEs 270a, 270b, 270c or from other UEs using LTE/5G technology, and may notify the platform 265 regarding these communications. Based on this information, the platform 265 may calculate or identify a quantity of legacy devices that are within the coverage area, and may utilize this to determine if there is a need to adjust the allocation of the available spectrum for supporting legacy devices. As an example, in a case where the platform 265 determines that the quantity of legacy LTE and/or 5G devices in the coverage area has decreased from 100 to 50, then the platform 265 may reduce the allocated spectrum for legacy devices from, say, about 20% of the LTE spectrum to about 5% of the LTE spectrum and/or about 20% of the 5G spectrum to about 5% of the 5G spectrum. This may result in an RU (e.g., only) utilizing about 5% of the LTE spectrum to transmit/receive LTE signaling and/or (e.g., only) utilizing about 5% of the 5G spectrum to transmit/receive 5G signaling. Conversely, in a case where the platform 265 determines that the quantity of legacy devices has increased from 100 to 200, the platform 265 may increase the allocated spectrum for legacy devices from, say, about 20% of the LTE spectrum to about 30% of the LTE spectrum and/or from about 20% of the 5G spectrum to about 30% of the 5G spectrum.

In some embodiments, the platform 265 may determine a rate of increase or decrease in the quantity of legacy devices that are present in the coverage area based on information received from the network monitoring systems over time. For instance, if the platform 265 determines that the quantity of legacy LTE and/or 5G devices that are present has increased by a rate that is greater than a threshold, such as 15% over the past five minutes, then the platform 265 may increase the spectrum allocation for legacy devices from, say, about 10% of the LTE spectrum to about 25% of the LTE spectrum and/or about 10% of the 5G spectrum to about 25% of the 5G spectrum. Conversely, if the platform 265 determines that legacy LTE and/or 5G device usage is decreasing by a rate that is greater than a threshold, such as 20% over the past five minutes, then the platform 265 may decrease the spectrum allocation from, say, about 15% of the LTE spectrum to about 5% of the LTE spectrum and/or from about 15% of the 5G spectrum to about 5% of the 5G spectrum. In this way, the platform 265 may dynamically adjust or program the resource allocations to allow for communications with legacy LTE and/or 5G devices, while also serving 6G devices which might generate the majority of the traffic.

In one or more embodiments, the platform 265 may be implemented in a CU that is communicatively coupled to multiple DU/RU pairs, and may adaptively configure different DU/RU pairs to operate differently. For instance, assume that the CU is communicatively coupled to a first DU that is in communication with a first RU, and that the CU is also communicatively coupled to a second DU that is in communication with a second RU. The platform 265 may allocate different amounts of resources (e.g., different amounts of spectral bandwidth) for the first DU/RU pair for supporting legacy devices relative to the second DU/RU pair, depending on the quantities of the different types of devices or associated RATs that are being served in the respective coverage areas of the first and second RUs and/or based on the traffic load(s) that are associated with those devices/RATs. As an example, in a case where the first RU provides coverage for a first area and a quantity of legacy devices that are present in the first area is less than a particular threshold or if a traffic load associated with the legacy devices is less than a certain threshold, and where the second RU provides coverage for a second area and a quantity of legacy devices that are present in the second area is greater than the particular threshold or if a traffic load associated with the legacy devices is greater than the certain threshold, the platform 265 may effect a first allocation of resources (e.g., spectrum) for the first DU/RU pair for supporting the legacy devices that is smaller than a second allocation of resources (e.g., spectrum) for the second DU/RU pair. For instance, the platform 265 may configure the second DU/RU to utilize more of the LTE/ 5G spectrum (e.g., 50% of the total LTE/ 5G spectrum) and less 6G spectrum (e.g., 80% of the total 6G spectrum), and may configure the first DU/RU to utilize less of the LTE/ 5G spectrum (e.g., 20% of the total LTE/ 5G spectrum) and more 6G spectrum (e.g., 99% of the total 6G spectrum).

In some implementations of the open cloud RAN 262a, a given DU may coordinate with or control multiple RUs. For instance, multiple RUs (e.g., antennas) may be installed on a tower top, with some of the RUs being configured to operate in some frequency bands (e.g., LTE, 5G) and other RUs being configured to operate in other frequency bands (e.g., 6G). Alternatively, each of the RUs may be configured to operate across all bands. In such a case, the platform 265 may adjust resource allocations at least in part by adjusting the quantity of RUs that operate in one frequency band or another. As an example, in a case where there are ten RUs that serve a region, where one of the RUs is (e.g., by default) initially set to operate in the LTE band, and where more resources are to be allocated for LTE signaling so as to support an increased amount of LTE devices in the region, the platform 265 may cause one or more of the other nine RUs to operate in the LTE band.

In various embodiments, the platform 265 may be configured to facilitate translations of signaling between RATs. The platform 265 may include or leverage AI/ML model(s) that are trained to convert signaling message content from one signaling format to another, such as from an LTE signaling format to a 5G or 6G signaling format and/or vice versa. This advantageously allows a 6G core, for instance, to understand the signaling from a legacy LTE/5G device. In this way, the AI/ML capabilities of the platform 265 enable the open cloud RAN 262a to “transform” into an “LTE RAN” from the perspective of legacy LTE devices.

For example, in a case where a legacy LTE device sends LTE-based signaling to an RU—e.g., as part of a random access procedure—the platform 265 in a corresponding DU may first recognize the signaling format. Continuing the example, the platform 265 may read the signaling format and identify it—e.g., by leveraging the AI/ML model(s)—as originating from an LTE device. Further continuing the example, the platform 265 may translate the LTE-based signaling into 6G-based signaling for communication with the core network. The translation may be performed by mapping the LTE signaling parameters to their 6G equivalents so as to ensure compatibility with the 6G core network protocols. The mapping can be performed using look-up tables that store mappings between LTE signaling parameters and 6G signaling parameters and/or via AI/ML model(s) that have been trained to do the conversions.

In certain embodiments, the core network 290 may be software defined/virtualized. In these embodiments, an instance of the platform 265 may be implemented in the core network 290 to facilitate signaling translations directly at the core network 290, rather than in the CUs/DUs.

In various embodiments, the platform 265 or at least a portion of its functionalities may be implemented in a RIC. In one or more embodiments, the platform 265 may be configured to balance or adjust resource usage among the various RATs, including memory usage, processor usage, and/or the like. For example, in a case where there is an increase in the presence of legacy LTE/5G devices, the platform 265 may allocate more processing power and memory in a CU and/or DU to handle the increased signaling and data processing demands of these legacy devices. Implementing at least a portion of the platform 265 in the RIC allows for resource allocation adjustments that take into account the aggregated “global view” of the overall available network resources that the RIC generally has given its position in the RAN architecture.

In one or more embodiments, the platform 265 may be configured to perform application-aware AI/ML-driven resource allocation within the RAN. The platform 265 may monitor the applications that are executing on devices (e.g., by obtaining data from network monitoring systems that indicate the types of applications being used), and may group the devices by application type, e.g., with or without regard to RAT generation. The platform 265 may then allocate RAN resources based on the application types to improve overall user experience. For instance, in a case where a high number of video streaming applications are being used by the devices, the platform 265 may allocate more bandwidth to those devices such that buffering is reduced or minimized. As another example, in a different case where a significant number of devices are running low-latency applications, such as online gaming or real-time video conferencing, the platform 265 may prioritize resource allocation to those devices such that latency is reduced. As a further example, in a case where a greater number of the devices running low-latency applications are LTE/5G devices, the platform 265 may cause the corresponding RU to utilize more of the LTE/5G spectrum and less of the 6G spectrum.

It will be understood and appreciated that embodiments of the platform 265 enable AI/ML-driven analysis of network key performance indicators (KPIs) and user experience. The platform 265 may enhance the overall user experience across multi-generation devices by dynamically allocating and adjusting the RAN resource share to the corresponding device groups.

It is to be understood and appreciated that, although one or more of FIGS. 1B and 2A might be described above as pertaining to various processes and/or actions that are performed in a particular order, some of these processes and/or actions may occur in different orders and/or concurrently with other processes and/or actions from what is depicted and described above. Moreover, not all of these processes and/or actions may be required to implement the systems and/or methods described herein. Furthermore, while various components, devices, systems, modules, networks, units, platforms, controllers, etc. may have been illustrated in one or more of FIGS. 1B and 2A as separate components, devices, systems, modules, networks, units, platforms, controllers, etc., it will be appreciated that multiple components, devices, systems, modules, networks, units, platforms, controllers, etc. can be implemented as a single component, device, system, module, network, unit, platform, controller, etc., or a single component, device, system, module, network, unit, platform, controller, etc. can be implemented as multiple components, devices, systems, modules, networks, units, platforms, controllers, etc. Additionally, functions described as being performed by one component, device, system, module, network, unit, platform, controller, etc. may be performed by multiple components, devices, systems, modules, networks, units, platforms, controllers, etc., or functions described as being performed by multiple components, devices, systems, modules, networks, units, platforms, controllers, etc. may be performed by a single component, device, system, module, network, unit, platform, controller, etc.

FIG. 2B depicts an illustrative embodiment of a method 250 in accordance with various aspects described herein.

At 252, the method can include allocating RAN resources to support first devices that utilize a first RAT and second devices that utilize a second RAT, resulting in a resource allocation. For example, the platform 265 can, similar to that described above with respect to the system 200 of FIG. 2A, perform one or more operations that include allocating RAN resources to support first devices that utilize a first RAT and second devices that utilize a second RAT, resulting in a resource allocation.

At 254, the method can include obtaining information regarding a quantity of the first devices, a quantity of the second devices, traffic loads associated with the first devices, traffic loads associated with the second devices, or a combination thereof. For example, the platform 265 can, similar to that described above with respect to the system 200 of FIG. 2A, perform one or more operations that include obtaining information regarding a quantity of the first devices, a quantity of the second devices, traffic loads associated with the first devices, traffic loads associated with the second devices, or a combination thereof.

At 256, the method can include adjusting the resource allocation based on the information. For example, the platform 265 can, similar to that described above with respect to the system 200 of FIG. 2A, perform one or more operations that include adjusting the resource allocation based on the information.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

The platform 265 may be configured to perform one or more of it above-described functions by leveraging one or more AI/ML model(s) that have been trained to facilitate those functions. In various embodiments, the AI/ML model(s) may be trained via an AI architecture (e.g., an AI architecture 260 illustrated in FIG. 2C and described in more detail below). In certain embodiments, the AI/ML model(s) may include one or more LLMs, one or more transformer-based models, one or more auto-regressive models, one or more of another type of generative AI model, or a combination of some or all of these models. As an example, the AI/ML model(s) may include one or more LLMs that are based on the transformer model 270 illustrated in FIG. 2D and described in more detail below.

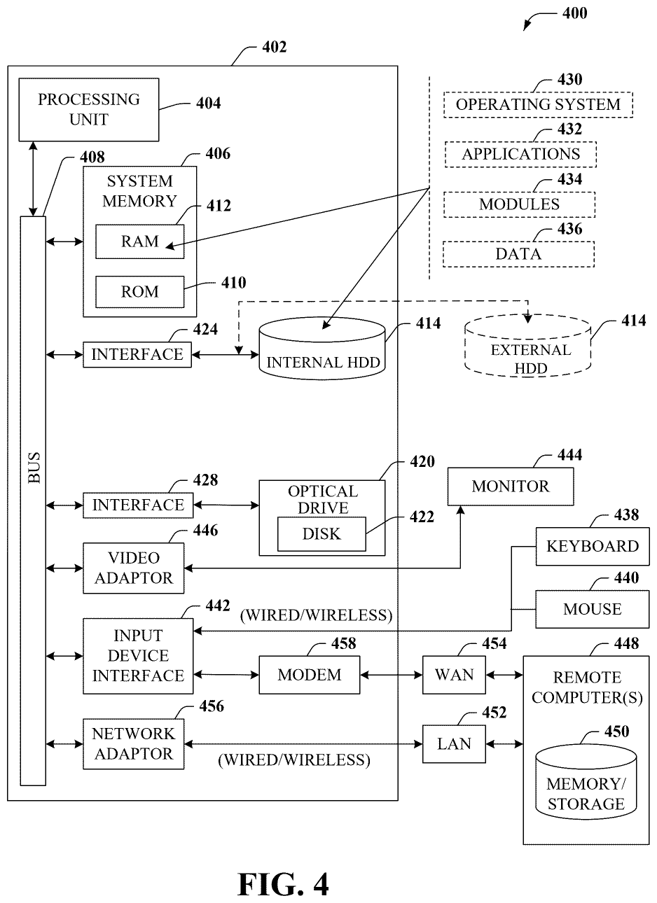

Referring to FIG. 2C, an example AI architecture 260 may be used to facilitate training and/or pre-training of AI models, such as the AI/ML model(s) described above with respect to one or more of FIGS. 2A and 2B. For instance, the AI architecture 260 may be used to facilitate training and/or pre-training of an LLM associated with the platform 265, which may be or may include an LLM that is based on the transformer model 270 illustrated in FIG. 2D and described in more detail below. The AI architecture 260 may include an input module 262, a preprocessor 264, and a training module 266. Some or all of these modules, which may be referred to as programs, processors, or agents, may be realized based on execution of instructions or data by one or more processors of a computing (or ML) system, such as the computing system 400 of FIG. 4 (described in more detail below).

The input module 262 may allow for input of (e.g., user-provided) data, such as datasets, parameters (e.g., weights, biases, and/or the like), etc., that can be used to train models and/or obtain predictions from models. In some cases, datasets may be labeled and may include inputs (e.g., observed or measured values) and known output data. Labeled datasets may facilitate supervised (or guided) learning.

Although not shown, the AI architecture 260 may include a library of ML models or algorithms, such as, for instance, one or more classifiers (e.g., a naïve Bayes classifier or the like), one or more support vector machines, one or more artificial neural networks (e.g., transformer neural networks, convolutional neural networks, and/or the like), one or more learned decision trees, and so on. Each of the ML algorithms may be associated with various parameters.

The preprocessor 264 may be equipped with one or more preprocessing algorithms that are configured to prepare input datasets for processing by the training module 266. Such preprocessing may include discretization (where values are binned or converted into nominal values), component analysis, data estimation, feature selection, feature extraction (e.g., dimensionality reduction, data removal, statistical analysis, threshold-based filtering, etc.), data interpolation, and/or the like.

The training module 266 may be configured to train and evaluate ML models. As an example, the training module 266 may be configured to perform unsupervised learning and/or supervised learning based in input datasets. In exemplary embodiments, the training module 266 may be capable of training and/or evaluating the performance of multiple models in parallel. In one or more implementations, the training module 266 may, despite operating on multiple ML models in parallel, train and evaluate the various ML models individually. In some implementations, the training module 266 may be capable of combining the procedure outcomes of multiple models to derive an aggregate outcome. Model evaluation or validation may involve a comparison of model outputs to known outputs or an analysis of model outputs relative to desired metrics.

In exemplary embodiments, certain processing techniques may be employed to generate usable data sets for feeding into the AI architecture 260 to train deep learning neural network model(s) to output predictions. Although not shown, the AI architecture 260 may include additional functional modules, such as those for gathering performance results and presenting (e.g., displaying) data regarding the results. While various components, modules, etc. may have been illustrated in FIG. 2C as separate components, modules, etc., it will be appreciated that multiple components, modules, etc. may be implemented as a single component, module, etc., or a single component, module, etc. may be implemented as multiple components, modules, etc. Additionally, functions described as being performed by one component, module, etc. may be performed by multiple components, modules, etc., or functions described as being performed by multiple components, modules, etc. may be performed by a single component, module, etc.

Referring to FIG. 2D, an example transformer model 270 (a portion or an entirety of which may serve as a functional building block of one or more LLMs (e.g., LLM(s) associated with or included in the platform 265, such as the AI/ML model(s) described above with respect to one or more of FIGS. 2A and 2B)) may include an encoder 272 and a decoder 274. The encoder 272 may include an input embedding block 272b, a positional encoder 272c, and a series of (i.e., multiple (Nx)) identical layers that each has a multi-head attention block 272m and a feed forward block 272f. An input (e.g., text, such as a query or a prompt) may be converted into individual tokens (e.g., words, characters, etc.) that are fed into the input embedding block 272b. The input embedding block 272b may convert the tokens into continuous vectors, where each token is mapped to a high-dimensional space by way of a learned embedding matrix. The embedding matrix may be implemented in a lookup table or the like, where token indexes are associated with different vectors of a fixed size. The positional encoder 272c may derive fixed positional encodings or learned positional encodings to help capture positional information of tokens. Fixed positioning encodings may be generated using sinusoidal functions, where the different frequencies of sine/cosine functions correspond to unique positional encodings for the different positions in a given sequence. Learned positional encodings may be learned during training based on initially randomly chosen values that are optimized as part of the training process. In any case, the positional encodings may be combined with the input embeddings from the input embedding block 272b on an element-by-element basis, resulting in a processed input that may be fed into the series of layers. The processed input may be fed into the multi-head attention block 272m in the first layer. An addition (or residual connection) and normalization block 272x may operate on the processed input and the output of that multi-head attention block 272m. The output of the addition and normalization block 272x may be passed to the feed forward block 272f in that layer. An addition and normalization block 272y may operate on the output of the addition and normalization block 272x and the output of the feed forward block 272f. In essence, the multi-head attention block 272m of a given layer may enable the feed forward block 272f in that layer to model long term dependencies. Multi-head attention allows the model to simultaneously attend to different parts of the input sequence and weigh their importance based on the input sequence's internal relationships. This attention mechanism may be combined with the input sequence's representations to produce a new set of weighted representations. Iterating the identical layers allows the model to learn complex patterns and relationships in the data.

The decoder 274 may include an output embedding block 274b, a positional encoder 274c, and a series of (i.e., multiple (Mx)) identical layers that each has a masked multi-head attention block 274k, a multi head attention block 274m, and a feed forward block 274f. An output (shifted right) may be converted into individual tokens that are fed into the output embedding block 274b. The output embedding block 274b may convert the tokens into continuous vectors. The positional encoder 274c may derive fixed positional encodings or learned positional encodings to help capture positional information of tokens. The processed output may be fed into the masked multi-head attention block 274k in the first layer. An addition and normalization block 274w may operate on the processed output and the output of that masked multi-head attention block 274k. The output of the addition and normalization block 274w may be passed to the multi-head attention block 274m in that layer. Output(s) from the encoder 272 may also be fed into the multi-head attention block 274m. An addition and normalization block 274x may operate on the output of the addition and normalization block 274w and the output of multi-head attention block 274m. The output of the addition and normalization block 274x may be passed to the a feed forward block 274f in that layer. An addition and normalization block 274y may operate on the output of the addition and normalization block 274x and the output of the feed forward block 274f. The output of the addition and normalization block 274y may may be passed to a linear layer 274r, which may transform that output into a higher-dimensional space. The output of the linear layer 274r may be fed into a softmax layer 274s, which may be a non-linear activation function that normalizes the output to a probability distribution to ensure that all values are non-negative and add up to 1. Iterating the identical layers allows the model to learn complex patterns and relationships in the data.

Various types of transformer-based LLMs may be constructed by “stacking” the identical layers of the encoder 272 and/or the decoder 274 in particular arrangements and in combination with additional refinements/components. A given LLM constructed as such may then be trained or pre trained (e.g., using the AI architecture 260 of FIG. 2C, a similar AI architecture, a different AI architecture or a combination of some or all of these AI architectures) on a corpus of information and/or finetuned or instruction tuned to analyze/generate data (e.g., text, audio, and/or images).

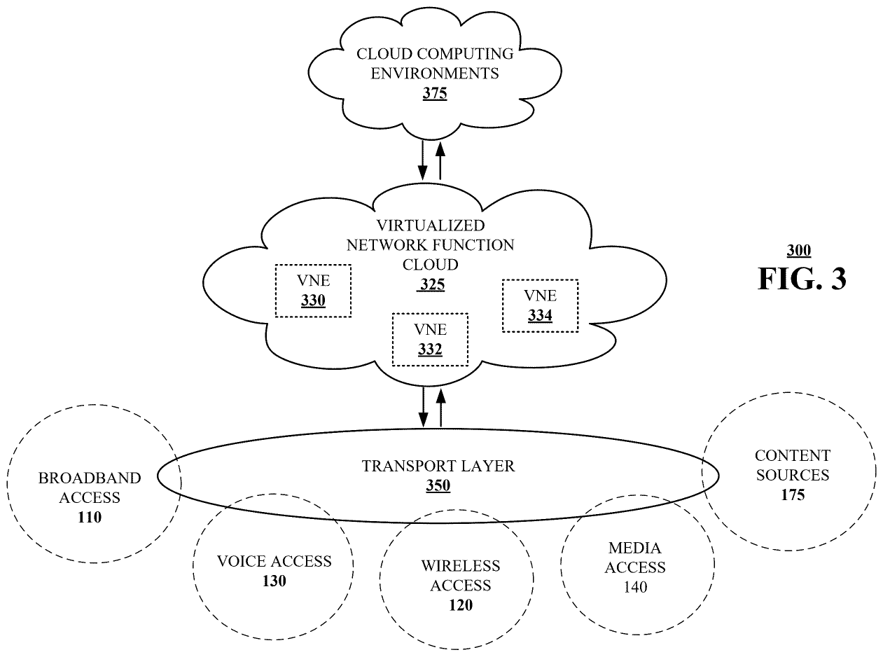

Referring now to FIG. 3, a block diagram 300 is shown illustrating an example, non-limiting embodiment of a virtualized communications network in accordance with various aspects described herein. In particular, a virtualized communications network is presented that can be used to implement some or all of the subsystems and functions of system 100, the subsystems and functions of system 160, the subsystems and functions of system 200, and method 250 presented in FIGS. 1A, 1B, 2A, and 2B. For example, virtualized communications network 300 can facilitate, in whole or in part, AI-/ML-driven open cloud RAN programmability to support legacy and non-legacy devices.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communications network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward substantial amounts of traffic, their workload can be distributed across a number of servers—each of which adds a portion of the capability, and which creates an overall elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate, in whole or in part, AI-/ML-driven open cloud RAN programmability to support legacy and non-legacy devices.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), and an optical disk drive 420, (e.g., reading a CD-ROM disk 422 or, to read from or write to other high capacity optical media such as the DVD). The HDD 414, and optical disk drive 420 can be connected to the system bus 408 by a hard disk drive interface 424 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communications network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

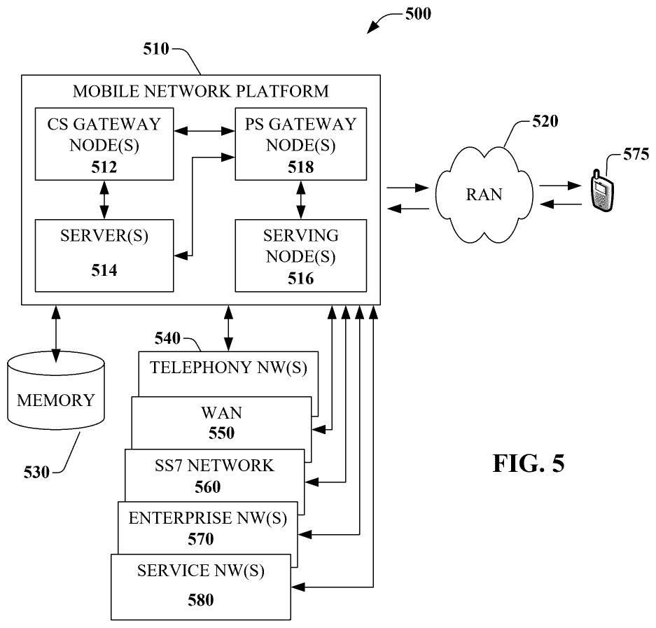

Turning now to FIG. 5, an embodiment 500 of a mobile network platform 510 is shown that is an example of network elements 150, 152, 154, 156, and/or VNEs 330, 332, 334, etc. For example, platform 510 can facilitate, in whole or in part, AI-/ML-driven open cloud RAN programmability to support legacy and non-legacy devices. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, which facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as distributed antenna networks that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

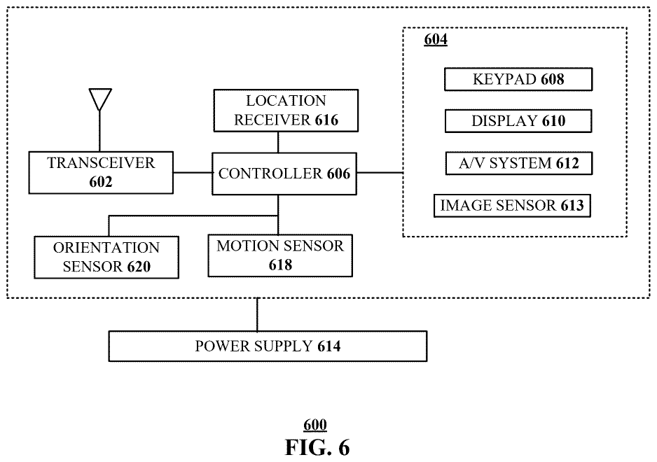

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via communications network 125. For example, computing device 600 can facilitate, in whole or in part, AI-/ML-driven open cloud RAN programmability to support legacy and non-legacy devices.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communications network) can employ various AI-based schemes for conducting various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communications network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to,” “coupled to,” and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
allocating radio access network (RAN) resources to support first devices that utilize a first radio access technology (RAT) and second devices that utilize a second RAT, resulting in a resource allocation;
obtaining information regarding a quantity of the first devices, a quantity of the second devices, traffic loads associated with the first devices, traffic loads associated with the second devices, or a combination thereof; and
adjusting the resource allocation based on the information.

2. The device of claim 1, wherein the first RAT comprises Long Term Evolution (LTE) or 5G.

3. The device of claim 1, wherein the second RAT comprises 5G or 6G.

4. The device of claim 1, wherein the second RAT is a higher generation technology than the first RAT.

5. The device of claim 1, wherein the RAN resources comprise spectrum resources associated with the first RAT and the second RAT.

6. The device of claim 5, wherein the allocating comprises allocating only a fraction of a first spectrum resource or a first bandwidth that is associated with the first RAT.

7. The device of claim 6, wherein the fraction of the first spectrum resource or the first bandwidth that is associated with the first RAT comprises a default allocation amount.

8. The device of claim 6, wherein, responsive to the allocating, System Information Blocks (SIBs) for the first RAT are broadcast using only the fraction of the first spectrum resource or the first bandwidth.

9. The device of claim 1, wherein the information indicates an increase in the quantity of the first devices, a decrease in the quantity of the second devices, or a combination thereof.

10. The device of claim 9, wherein the adjusting comprises increasing an allocation of RAN resources for the first RAT, decreasing an allocation of RAN resources for the second RAT, or a combination thereof.

11. The device of claim 1, wherein the information indicates an increase in the traffic loads associated with the first devices, a decrease in the traffic loads associated with the second devices, or a combination thereof.

12. The device of claim 11, wherein the adjusting comprises increasing an allocation of RAN resources for the first RAT, decreasing an allocation of RAN resources for the second RAT, or a combination thereof.

13. The device of claim 1, wherein the adjusting involves use of one or more artificial intelligence (AI) models that are trained to predict adjustments to resource allocations.

14. A non-transitory machine-readable medium, comprising executable instructions that, when executed by a processing system including a processor, facilitate performance of operations, the operations comprising:
allocating radio access network (RAN) resources to support first devices that utilize a first radio access technology (RAT) and second devices that utilize a second RAT, resulting in a resource allocation, wherein the allocating comprises allocating only a portion of a first spectrum resource or a first bandwidth that is associated with the first RAT;
obtaining data regarding a quantity of the first devices, a quantity of the second devices, traffic loads associated with the first devices, traffic loads associated with the second devices, or a combination thereof; and
adjusting the resource allocation based on the data.

15. The non-transitory machine-readable medium of claim 14, wherein the second RAT is a higher generation technology than the first RAT.

16. The non-transitory machine-readable medium of claim 14, wherein, responsive to the allocating, System Information Blocks (SIBs) for the first RAT are broadcast using only the portion of the first spectrum resource or the first bandwidth.

17. The non-transitory machine-readable medium of claim 14, wherein the RAN resources comprise spectrum resources associated with the first RAT and the second RAT.

18. A method, comprising:
allocating, by a processing system including a processor, radio access network (RAN) resources to support first devices that utilize a first radio access technology (RAT) and second devices that utilize a second RAT, resulting in a resource allocation, wherein the processing system comprises or is included in a control or centralized unit (CU) or a distributed unit (DU) of an open cloud RAN;
obtaining, by the processing system, information regarding a quantity of the first devices, a quantity of the second devices, traffic loads associated with the first devices, traffic loads associated with the second devices, or a combination thereof; and
adjusting, by the processing system, the resource allocation based on the information.

19. The method of claim 18, wherein the second RAT is a higher generation technology than the first RAT.

20. The method of claim 18, wherein the allocating comprises allocating only a fraction of a first spectrum resource or a first bandwidth that is associated with the first RAT, and wherein, responsive to the allocating, System Information Blocks (SIBs) for the first RAT are broadcast using only the fraction of the first spectrum resource or the first bandwidth.
